(19) United States
(12) Patent Application Publication
(10) Pub. No.: US 2008/0058473 A1
(43) Pub. Date: Mar. 6, 2008

(54) Latex for low VOC paint having improved block resistance, open time and water-softening resistance

(76) Inventors: Yakov Freidzon, Bridgewater, NJ (US); Ning Wu, Edison, NJ (US); Michael Bochnik, Yonkers, NY (US); Robert Sheerin, North Caldwell, NJ (US); Barry Chadwick, Fairfield, CT (US)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 11/513,859

(22) Filed: Aug. 31, 2006

(51) Int. Cl. C08F 8/00

(52) U.S. Cl. 525/191

(57) ABSTRACT

The invention is directed to latex compositions comprising sequentially designed polymer having a first stage, a second stage and a third stage corresponding to a seed, a core and a shell. The latex polymer is suitable for aqueous low volatile organic compounds (“VOC”) paint (less than 50 g/L) with good block resistance, improved open time and increased water softening resistance. To attain good block resistance, the seed and the core contain monomers that form polymers with relatively harder characteristics and higher glass transition temperature (“T_{g}”) while the shell contains monomers that form polymers with softer characteristics and lower T_{g}. To gain improved open time, the latex polymer contains suitable level of hydrophilic monomers necessary to hold water. To achieve water softening resistance, hydrophobic monomers are grafted on hydrophilic portions of the shell or the core layers. The invention is also directed to the process of making the latex by a sequential emulsion polymerization.

### FIELD OF THE INVENTION

The present invention is directed to latex for low volatile organic compounds (less than 50 g/L) aqueous paint composition, comprising a sequentially designed polymer. The latex possesses desirable properties such as block resistance, improved open time and resistance to water-softening, and can be used to form a polymeric surfactant or a pigment dispersant.

### BACKGROUND OF THE INVENTION

Conventional paint compositions are based on polymers with relatively high glass transition temperature (“T_{g}”) and coalescing agents that are volatile organic compounds (“VOC”). To reduce the level of VOC, polymers with relatively low T_{g} can be utilized, but they can lead to poor paint properties such as poor block resistance and dirt pick up.

U.S. Pat. No. 5,990,228 (the '228 patent) is related to aqueous coating compositions containing at least two polymer components which provide adhesion and improved durability, as measured in dried coatings made from the aqueous compositions by improved gloss retention or dirt pickup resistance. The '228 patent discloses a comparative example using a 60 nm preformed latex core of butyl acrylate (BA)/methyl methacrylate (MMA)/methacrylic acid (MAA), upon which two layers of BA/MMA/acrylic acid (AA) with similar compositions were added. However, the '228 patent does not disclose a seed, a core and a shell as the structural component of the latex. Furthermore, the comparative example in the '228 patent discloses a core and two subsequent layers such that each layer contain a mixture of soft, hard and hydrophilic monomers.

International Publication No. WO 94/04581 (the '581 publication) is related to waterborne latex containing core-shell acrylic particles adapted for spray application. The core contains 50-90 wt % acrylic and methacrylic monomers and 1-20 wt % hydroxy-functional monomers, so as to form a polymer having a T_{g} below 0° C. The shell contains 40-90 wt % acrylic and methacrylic monomers, 5-20 wt % acid-containing monomers, and 1-20 wt % hydroxy-functional monomers, so as to form a polymer having a T_{g} above 20° C. In the '581 publication, the core comprises monomers that are relatively more hydrophobic, softer and with lower T_{g} values than those monomers in the shell.

European Patent Application No. EP 0 614 919 A1 (the '919 application) describes a latex composition containing a core-shell type polymer particles in which the core is made from 50-90 wt % vinyl C₁-C₄ alkanoate monomers and 10-50 wt % monomers being vinyl esters of tertiary saturated carboxylic acids so as to form a polymer having a T_{g} of at least 10° C., and in which the shell is made from 10-50 wt % vinyl C₁-C₄ alkanoate monomers and 50-90 wt % monomers being vinyl esters of tertiary saturated carboxylic acids so as to form a polymer having a T_{g} below 10° C. The '919 application specifically requires vinyl esters in both the core and the shell, and is not directed to using a seed on which the core and the shell are assembled.

U.S. Pat. No. 6,723,779 (the '779 patent) describes a low-temperature film-forming latex based on hydrophobic polymers in which crosslinking monomers, such as dienes, divinyl acrylates, and polyvinyl compounds are used so that the composition is self-curing. In the '779 patent, 70-90 wt % of the particles are the core polymer having a T_{g} below 20° C. and 10-30 wt % of the particle are the shell polymer having a T_{g} above 50° C.

U.S. Pat. No. 5,688,853 (the '853 patent) is directed to a soil resistant aqueous coating composition using a blend of a low T_{g} polymeric dispersion and a high T_{g} polymeric dispersion. In the '853 patent, the low T_{g} polymer dispersion is less than 0° C. and the high T_{g} polymer dispersion is at least 35° C., preferably 40-110° C., and most preferably 50-70° C. The '853 patent uses a blend rather than a seed, a core and a shell morphology for the aqueous coating composition.

U.S. Pat. No. 5,455,315 (the '315 patent) is related to an in situ process for the preparation of resin particles using a seed particle latex, a core polymer resin with T_{g} of about 20-50° C., and a shell polymer resin with T_{g} of about 50-90° C. The '315 patent is directed to a core with lower T_{g} values and a shell with higher T_{g} values.

U.S. Pat. No. 5,461,125 (the '125 patent) is related to waterborne core-shell latex polymers comprising a core using (meth)acrylate esters with T_{g} of −50-105° C. and a shell using a copolymer of nitrogen-bearing ethylenically-unsaturated monomer and (meth)acrylate. The '125 patent does not utilize a seed as part of the latex polymer.

U.S. Pat. No. 5,021,469 (the '469 patent) is related to binder for water-based gloss paints composition comprising a core having T_{g} at least 40° C. and preferably 90-150° C., and a shell having T_{g} below 70° C. and preferably 0-50° C. However, the '469 patent does not teach the use of a seed as part of the core-shell construction of the latex.

U.S. Pat. No. 4,384,096 (the '096 patent) is related to aqueous emulsion polymers having three ethylenically unsaturated monomeric components: a carboxylic acid monomer, a vinyl monomer and a vinyl surfactant ester. However, the '096 patent does not teach the use of a core and a shell as part of the latex.

U.S. Pat. No. 6,646,058 (the '058 patent) is related to a water-based paint composition having an opacifying pigment, a core-shell polymer with acidic functionality, and a polymer derived from a macromonomer with a hydrophobic portion and an alkyloxylated portion. The '058 patent specifically teaches that the monomers used to produce the core and the shell do not have “latent cross-linking capability”, and therefore the core and the shell do not have the ability to further react with the macromonomers.

Co-pending U.S. application Ser. No. 10/728,599 (the '599 application) is directed to copolymer surfactants comprising an ethylenically unsaturated carboxylic acid, an ethylenically unsaturated vinyl monomer, a surfactant monomer, and an ethylenically unsaturated cross-linking monomer.

Co-pending U.S. application Ser. No. 11/193,131 (the '131 application) is related to a colorant composition comprising, among additional components, a component having a hydrophobic latex polymer.

Thus, there remains a need for latex for low VOC aqueous paint composition having good block resistance, improved open time and resistance to water softening properties, and a method based on sequential emulsion polymerization for preparing the same.

### BRIEF SUMMARY OF THE INVENTION

The present invention relates to sequentially polymerized compounds that can be formulated as latexes for aqueous paints with desirable properties such as improved block resistance, improved open time, and resistance to water softening. These useful properties can be accomplished by varying the characteristics of the monomers that make up the sequentially polymerized compounds in the seed, the core, and the shell layers of the latex. First, using monomers that form polymers with different glass transition temperatures in the layers or stages result in polymers suitable for paints with good block resistance and other properties. Second, controlling the hydrophilicity of the monomers in the layers yield polymers that give rise to paints with improved open time and other properties. Third, attaching monomers with hydrophobic functional groups to the core or the shell layers give rise to polymeric surfactants or pigment dispersants for paints with resistance to water softening and other properties.

The first embodiment of the present invention is directed to latex polymer for low VOC aqueous paints with good block resistance and additional properties, comprising three stages such as a seed, a core and a shell that are sequentially polymerized. Monomers for the seed are those that form polymers having glass transition temperature (“T_{g}”) in the range of 30 to 110° C., preferably in the range of 70 to 110° C. Monomers for the core are those that form polymers having T_{g} in the range of 30 to 70° C. Monomers of the shell are those that form polymers having T_{g} in the range of −10 to 10° C. Alternatively, monomers for the seed are those that form polymers having T_{g} that changes gradually from the range of 70 to 110° C. to the range of 30 to 70° C., and monomers for the core are those that form polymers having T_{g} that changes gradually from the range of 30 to 70° C. to the range of −10 to 10° C. The latex polymer is suitable for paints with a volatile organic component (VOC) content of less than 50 g/L.

The second embodiment of the invention is directed to latex polymer for low VOC aqueous paints with improved open time and additional properties, comprising three stages, such as a seed, a core and a shell that are sequentially polymerized. By using up to about 15% of hydrophilic monomers such as acrylic acid, methacrylic acid, hydroxyethyl acrylate, hydroxyethyl methacrylate, polyethylene glycol monoacrylate, polyethylene glycol monomethacrylate, diacetone acrylamide, and acetoacetoxyethyl methacrylate in the core layer or the core layer, the latex polymer will hold water better and the paints derived therefrom will have improved open time. The amount of hydrophilic monomers in the shell layer may be less that that in the core layer. Sometimes, it is not necessary to have hydrophilic monomers in the shell at all.

The third embodiment of the invention is directed to latex polymer that functions as a polymeric surfactant or a pigment dispersant in paints with better resistance to water softening properties. Molecules with hydrophobic functional groups, or hydrophobes, can be attached to polymers, preferably hydrophilic polymers, in the shell by sequential polymerization to give rise to polymeric surfactants or pigment dispersants.

The fourth embodiment of the invention is directed to a sequential emulsion polymerization method for latex polymer for low VOC aqueous paints with good block resistance, improved open time and better resistance to water-softening. The method comprises the steps of: (a) preparing a monomer pre-emulsion mixture for a seed, (b) preparing a monomer pre-emulsion mixture for a core, (c) treating the monomer pre-emulsion mixture for seed with a solution of sodium persulfate to form a seed, (d) treating the seed with the monomer pre-emulsion mixture for core to form a core, and (e) treating the core with polymer components for a shell. The latex is suitable for a paint having a VOC content of less than 50 g/L.

### DETAILED DESCRIPTION OF THE INVENTION

The first embodiment of the invention is directed to aqueous latex compositions comprising a seed, a core and a shell that is suitable for low VOC paints (less than 50 g/L). The seed and the core contain monomers that form relatively harder polymers having higher T_{g} while the shell contains monomers that form relatively softer polymers having lower T_{g}. The latex possesses desirable properties including block resistance, shelf stability, low temperature coalescence, scrub resistance, stain removal, wet adhesion and can be used for paints with different finishes.

From a different perspective, the latex polymer comprises sequentially designed polymer having three stages: a first, a second, and a third. The first stage comprises a seed of the sequentially designed polymer, the second stage comprises a core of the sequentially designed polymer, and the third stage comprises a shell of the sequentially designed polymer. As used herein, sequentially designed polymers include but are not limited to, sequentially emulsified polymers and any multi-stage polymers, among others.

The seed layer comprises monomers that form polymers that are relatively “harder” and have higher T_{g} values. The range of T_{g} of the polymers derived from the monomers for the seed can be 10-130° C., preferably 30-110° C. When the paint is for semi-gloss finish, the T_{g} range of the polymers derived from the monomers of the seed can be 10-90° C., preferably 30-70° C. When the paint is for high-gloss finish, the T_{g} range of the polymers derived from the monomers for the seed can be 50-130° C., preferably 70-110° C.

The core layer comprises monomers that form polymers that are also relatively “harder” and have higher T_{g} values. The range of T_{g} of the polymers derived from the monomers for the core can be 10-90° C., preferably 30-70° C. In addition, the core layer may comprise hydrophilic and hydrophobic monomers, as well as wet adhesion monomer and optionally functional monomers.

The shell layer of the latex comprises monomers that form polymers that are relatively “softer” and have lower T_{g} values. The range of T_{g} of the polymers derived from the monomers for the shell can be −30-30° C., preferably −10-10° C. In addition, the shell layer may comprise hydrophilic and hydrophobic monomers, as well as wet adhesion monomer and optionally functional monomers.

In one variation, the T_{g} values of the polymers derived from the monomers in the seed layer may gradually change from higher values to lower values moving from the center of the seed toward the core layer. Similarly, the T_{g} values of the polymers derived from the monomers in the core layer may also gradually change from higher values to lower values moving from the core layer to the shell layer. The gradual changes of the T_{g} values of the polymers in the layers may add to the diversity of paint finishes while maintaining the desirable paint properties such as block resistance, and low temperature coalescence.

In another variation, there can be intermediate layer(s) between the seed and the core, and between the core and the shell. For the intermediate layer(s) between the seed and the core, the T_{g} values of the polymers therein will be between those of the polymers in the seed and the core. Similarly, for the intermediate layer(s) between the core and the shell, the T_{g} values of the polymers therein will be between those of the polymers in the core and the shell. These intermediate layers may also add to the diversity of paint finishes while maintaining the desirable paint properties such as block resistance, and low temperature coalescence.

The glass transition temperature (T_{g}) of a polymer is the temperature above which the polymer is rubbery and soft and below which the polymer is hard and glassy. The T_{g} values of polymers in the various layers of the latex particles can be obtained from Polymer Handbook, 3^{rd} ed. (1989), or from Robert B. Fox, “Glass Transition Temperature for Selected Polymers” in CRC Handbook of Chemistry and Physics, 81^{st} ed (2000), pages 13-4 through 13-11.

When the polymers in the seed, the core, or the shell are copolymers, the overall T_{g} of a particular layer of copolymers can be calculated by applying the T_{g} value of the homopolymer derived from each monomer to the Fox Equation:

(1/T_{g})=(Wₐ/T_{ga})+(W_{b}/T_{gb})+ . . . +(Wᵢ/T_{gi}), wherein

W₁, W₂, . . . and Wᵢ=weight percentages of monomers “a”, “b” . . . , and

T_{ga}, T_{gb} . . . and T_{gi}=T_{g} values of monomers “a”, “b”, . . . , and “i”

See U.S. Pat. No. 6,723,779 and International Publication No. WO 94/04581 for the application of the Fox Equation to the calculation of the T_{g} values of copolymers. The disclosure of the '779 patent and the '581 publication are incorporated herein by reference in their entireties.

In a variation, the seed, the core, and the shell can each be described in T_{g} values according to the Fox Equation. Furthermore, the entire latex polymer can be described with an aggregate T_{g} value (“ATGV”). When the gradient of the T_{g} values between layers decreases from the seed, the ATGV will attain a negative value, which can be designed as ATGV(−). When the gradient of the T_{g} values between the layers increases from the seed, the ATGV will attain a positive value, which can be designated as ATGV(+). Hence, the ATGV value is the T_{g} obtained by the Fox Equation presented in a vectorial format, i.e., increasing or decreasing from the first stage or seed. The ATGV(−) of the invention is in the range of 0 to 70° C., preferably in the range of 10 to 60° C., and more preferably in the range of 20 to 50° C.

The representation of the latex with a T_{g} value for a particular layer or as ATGV for the entire latex has several advantages. If the ATGV for the entire latex can be used to identify the latex, a consumer can choose a particular type of paint with an ATGV that is most suitable under a particular weather condition of the season. For example, it is suitable to use a paint having latex of lower ATGV for cooler environment. In comparison, a wider range of ATGV can be used for warmer environments.

In yet another variation, the minimum film forming temperature (“MFFT”) of the latex polymer is used to describe the overall characteristic of the latex having a seed, a core and a shell. The MFFT is the minimum temperature at which the latex will form a continuous film. Measured by ASTM D2354, MFFT indicates the temperature below which coalescence would not occur. The MFFT for the sequentially designed polymer of the present invention ranges from 0.5 to 4.0° C. or higher, as discussed below.

The chemical composition of the monomers in each layer of the latex will determine the hardness or softness, the hydrophobicity or hydrophilicity, and other physical characteristics of the latex composition. In general, using monomers that form polymers with higher T_{g} values will give rise to harder polymers for a particular layer in the latex. Similarly, using monomers that form polymers with lower T_{g} will result in softer polymers for a particular layer in the latex.

TABLE 1
T_{g} Values of Polymers Derived From Commonly Used Monomers

| Polymer | T_{g} Value (° C.) |
|---|---|
| Polyethylene | −125 |
| Polybutadiene | −78 |
| Poly(butyl acrylate) | −52 |
| Poly(ethyl acrylate) | −22 |
| Poly(vinyl acetate) | +30 |
| Poly(vinyl chloride) | +80 |
| Poly(methyl methacrylate) | +105 |
| Polystyrene | +105 |
| Polyacrylonitrile | +130 |

The latex composition of this invention uses monomers that form polymers of different hardness/softness, and different hydrophobicity/hydrophilicity for the seed, the core and the shell so that a wide range of properties of the latex can be achieved. As a whole, the latex may contain 10-50 wt % of monomers responsible for hardness, 30-60 wt % of monomers responsible for softness, and 2-15% of hydrophilic and functional monomers.

The monomers responsible for hardness include methyl methacrylate (MMA), styrene (S), and the like. The monomers responsible for softness include butyl acrylate (BA), 2-ethylhexyl acrylate (EHA), butyl methacrylate (BMA) and the like. The monomers responsible for hydrophilic and additional functional groups include acrylic acid (AA), methacrylic acid (MAA), hydroxyethyl acrylate (HEA), hydroxyethyl methacrylate, (HEMA), acetoacetoxyethyl methacrylate (AAEM), diacetone acrylamide (DAAM) and the like.

The monomers of the seed and the core would be relatively harder than the monomers of the shell. The monomers utilized for the seed and the core preferably include methyl methacrylate, butyl methacrylate, styrene and the like. The monomers utilized for the shell preferably include butyl acrylate, 2-ethylhexyl acrylate, hydroxyethyl methacrylate, butyl methacrylate and the like.

The core and/or the shell may contain monomers responsible for hydrophilic and additional functional groups include acrylic acid (AA), methacrylic acid (MAA), itaconic acid (IA), hydroxyethyl acrylate (HEA), hydroxyethyl methacrylate, (HEMA), acetoacetoxyethyl methacrylate (AAEM), diacetone acrylamide (DAAM) and the like. The inventive inclusion of hydrophilic monomers is discussed below in connection with the second embodiment.

Additional monomers that are suitable for the seed, the core, and the shell of this invention include (meth)acrylate-containing monomers, styrene-containing monomers, carboxyl group-containing of monomers, hydroxyl group-containing monomers, amide group-containing monomers, amino group-containing monomers, epoxy group-containing monomers and related oligomers. Further examples can be found in U.S. Pat. Publication No. 2002/0013405 by Sakaguchi et al., the disclosure of which is incorporated herein by reference in its entirety.

Examples of (meth)acrylate-containing monomers include methyl(meth)acrylate, ethyl(meth)acrylate, n-propyl(meth)acrylate, isopropyl(meth)acrylate, n-butyl(meth)acrylate, isobutyl(meth)acrylate, pentyl(meth)acrylate, 2-ethylhexyl(meth)acrylate, decyl(meth)acrylate, dodecyl(meth)acrylate, stearyl(meth)acrylate, α-chloroethyl(meth)acrylate, cyclohexyl(meth)acrylate, phenyl(meth)acrylate, methoxyethyl(meth)acrylate, ethoxyethyl (meth)acrylate, methoxypropyl(meth)acrylate, ethoxypropyl(meth)acrylate and the like.

Examples of styrene-containing monomers include styrene, methylstyrene, chlorostyrene, methoxystyrene and the like. Examples of carboxyl group-containing monomers include (meth)acrylic acid, crotonic acid, itaconic acid, itaconic acid half ester, maleic acid, maleic acid half ester and the like.

Examples of hydroxyl group-containing monomers include 2-hydroxyethyl(meth)acrylate, 2(3)-hydroxypropyl(meth)acrylate, 4-hydroxybutyl acrylate, mono(meth)acrylic acid ester of allyl alcohol polyhydric alcohol and the like.

Examples of amide group-containing monomers include (meth)acrylamide and maleinamide. Examples of amino group-containing monomers include 2-aminoethyl(meth)acrylate, dimethylaminoethyl(meth)acrylate, diethylaminoethyl(meth)acrylate, 3-aminopropyl(meth)acrylate, 2-butylaminoethyl(meth)acrylate, vinylpyridine and the like.

Examples of epoxy group-containing monomers and oligomers obtained by reacting an active hydrogen atom-containing ethylenic unsaturated monomer with an epoxy compound having at least 2 glycidyl groups, glycidyl(meth)acrylate or allylglycidyl ether; and N-methylol acrylamide having a N-methylol group, vinyl acetate, vinyl chloride, ethylene, butadiene, acrylonitrile, and a dialkyl fumarate.

The second embodiment of the invention is directed to water-retaining latexes for low VOC paints with good open time properties. The paints can be high gloss, semi-gloss, satin, eggshell and flat.

Open time of emulsion paint is the time interval during which freshly applied paint can be blended with subsequently applied paint without the appearance of lack of uniformity. Currently, one approach to extend open time is by adding glycols, which are regulated by environmental authorities. Another approach is to use commercially available open time prolongers, which are usually hydrophilic and could decrease water and scrub resistance. Some slow evaporating amines such as AMP95 (Dow Chemical) or Advantex (Arkema) provide open time advantage over ammonium hydroxide but the open time improvement may not be sufficient. In many low VOC water based paints, the dry times become unacceptably short.

By using latex that contains sufficient hydrophilic functionalities in the core layer and in the shell layer, the paint thus derived has an improved capability to hold water. As a result, open time of the paints is improved. Alternatively, most of the hydrophilic functionalities are preferably in the shell layer of the latex particles.

The latex composition for improved open time contains at least 3 wt % acrylic acid or methacrylic acid, at least 2 wt % of hydroxyethyl methacrylate. The latex may also contain other hydrophilic monomers such as polyethylene glycol monoacrylate, polyethylene glycol monomethacrylate, diacetone acrylamide, acetoacetoxyethyl methacrylate and the like. Preferably, the latex contains about 4-7% methacrylic acid, about 2-5% hydroyethyl methacrylate, and about 3-6% diacetone acrylamide.

The latex of the present invention, without being bound by any theory, provides better open time during application than conventional latexes while having good dry film properties. This is because the hydrophilic monomers slow down the evaporation of water by forming hydrogen bond with water.

The third embodiment of the invention is directed to a polymeric surfactant or a pigment dispersant comprising a sequentially polymerized latex having at least two stages being chemically bonded to hydrophobic molecules or macromolecules. Preferably the hydrophobes are bonded to a hydrophilic second stage or shell. The reactive moiety of the hydrophobes can be bonded to the second stage or shell to become a part of the second stage or shell, or the reactive moiety can attach itself to reactive sites on the second stage or shell. The hydrophobes, therefore, can be viewed as side chains on the second stage of the latex.

The hydrophobic molecules or hydrophobes include at least one acrylic ester or methacrylic ester, i.e., a (meth)acrylic ester, of an ethoxylated moiety, such as alkyl, alkylphenyl, monostyrylphenyl, distyrylphenyl, tristyrylphenyl and the like, having the structure:

H₂C═C(X)—C(O)O-E-R

where

### X is hydrogen or methyl,

### E is ethoxylate, a hydrophilic moiety, and

R is alkyl, alkylphenyl, monostyrylphenyl, distyrylphenyl or tristyrylphenyl, i.e., a hydrophobic moiety. Preferably the X moiety is a functional segment that is attachable to the core-shell or sequentially polymerized latex. The latex may have more than two stages, e.g., seed-core-shell, as discussed above.

Exemplary hydrophobic molecules include the acrylic or methacrylic acid esters of nonionic surfactant alcohols, such as alkylpolyethyleneoxy(meth)acrylates or alkylphenylpolyethyleneoxy(meth)acrylates, where the alkyl group contains, independently, from 1 to 30 carbon atoms, and the tristyrylphenylpoly(ethyleneoxy) (meth)acrylates.

The term “tristyrylphenyl,” when used either alone or as a portion of a chemical name and unless otherwise indicated, includes monostyrylphenyl, distyrylphenyl, tristyrylphenyl, or a mixture thereof.

The alkylpolyethyleneoxy(meth)acrylate or alkylphenylpolyethyleneoxy (meth)acrylate has an alkyl group which contains, independently, from 1 to 22 carbon atoms. In one variation, the alkylpolyethyleneoxy(meth)acrylate or alkylphenylpolyethyleneoxy(meth)acrylate has an alkyl group which contains, independently, from 9 to 22 carbon atoms.

The hydrophobic molecules can be nonylpoly(ethyleneoxy)acrylate, decylpoly(ethyleneoxy)acrylate, undecylpoly(ethyleneoxy)acrylate, oleylpoly(ethyleneoxy)methacrylate, behenylpoly(ethyleneoxy)methacrylate, tristyrylphenylpoly(ethyleneoxy)methacrylate, or a mixture thereof.

The hydrophobic molecules may also be behenylpoly(ethyleneoxy)acrylate, behenylpoly(ethyleneoxy)methacrylate, decylpoly(ethyleneoxy)acrylate, decylpoly(ethyleneoxy)methacrylate, tristyrylphenylpoly(ethyleneoxy)acrylate, tristyrylphenylpoly(ethyleneoxy)methacrylate, or a mixture thereof.

Alternatively, the hydrophobic molecules may be behenylpoly(ethyleneoxy)methacrylate, decylpoly(ethyleneoxy)acrylate, tristyrylphenylpoly(ethyle-neoxy)acrylate, tristyrylphenylpoly(ethyleneoxy)methacrylate, or a mixture thereof.

The hydrophobic molecules may be tristyrylphenylpoly(ethyleneoxy)acrylate, tristyrylphenylpoly(ethyleneoxy)methacrylate, or a mixture thereof. Preferably, the hydrophobic molecules is tristyrylphenylpoly(ethyleneoxy)acrylate. More preferably, the hydrophobic molecules is tristyrylphenylpoly(ethyleneoxy)methacrylate.

In each of the examples of hydrophobic molecules containing ethyleneoxy groups, the number of ethylene oxide units present is from about 4 to about 200. Alternatively, in each of the above variations relating to a hydrophobic molecules containing ethyleneoxy groups, the number of ethylene oxide units present is from about 4 to about 60, preferably from about 10 to about 40.

In one variation, one or more hydrophobes can be chemically bonded to the hydrophilic shell of the latex particle.

Preferably, the hydrophobes make upabout 0.01% to about 20% by weight, based on the total weight of all monomers present in the latex, more preferably from about 0.03% to about 16% by weight, and most preferably from about 0.5% to about 13% by weight, based on the total weight of all monomers present in the shell layer.

Additional examples of surfactants can be found in co-pending U.S. application Ser. No. 10/728,559, which is incorporated herein by reference in its entirety. Also, surfactant monomers can be found among the polymerizable alkoylated compounds in U.S. Pat. No. 6,933,415, which is incorporated herein by reference in its entirety.

The preferred hydrophobes include behenyl polyethoxy methacrylate, oleyl polyethoxy methacrylate, alkylether polyethoxy acrylate, and tristyrylphenylpoly(ethyleneoxy)methacrylate (or known as Sipomer (SEM25™)).

The fourth embodiment of the invention is directed to the process of making the latex by a sequential emulsion polymerization that constructs a seed, a core and a shell with appropriate monomers. The presence of the seed, the core and the shell is the result of a sequential emulsion polymerization process. By controlling the type of monomers in each layer of the latex, the latex composition is suitable for low VOC paints and substantially zero VOC paints with good block resistance, improved open time, water-softening resistance, and other advantageous properties.

Polymerization can be categorized according to the homogeneous or heterogeneous nature of the system. Polymerization in homogeneous system can be conducted in batch mode, continuous mode or solution mode. Polymerization in heterogeneous system can be executed in suspension mode or emulsion mode. See “Chapter 6: Polymerization Conditions and Polymer Reactions” in Textbook of Polymer Science, Third Edition, F. W. Billmeyer, Jr. (Ed), the disclosure of which is incorporated herein by reference.

Emulsion polymerization can be carried out in a sequential manner or in a continuous manner. The method of latex formation of this invention is a multi-stage emulsion polymerization, because it involves at least three stages of polymerization.

In one aspect, the latex is sequentially polymerized in at least three stages so as to form at least three distinct phases: the first phase of a seed of relatively small size, the second phase of a core and the third phase of a shell, whereby the seed is the result of the first phase of the sequential emulsion polymerization, the core is the result of the second phase of the sequential emulsion polymerization, and the shell is the result of the third phase of the sequential emulsion polymerization.

The relative positions of the first and second phases of the polymer particles can be internal and external, as well as neighboring, dependent on how the first and second phases of the polymerization are performed. Similarly, the relative positions of the second and third phases of the polymer particles can be internal and external, or neighboring, dependent on how the second and the third phases of the sequential polymerization are carried out. Preferably, the relative positions of the first and the second phases of the polymer particles are internal and external. Also preferably, the relative positions of the second and the third phases of the polymer particles are internal and external.

The first phase of the sequential polymerization may comprise about 0.1-30 wt % of the latex, preferably about 0.5-20 wt %, and more preferably about 1.0-10 wt %. The second phase of the sequential polymerization may comprise about 5-90 wt % of the latex, preferably about 10-80 wt %, and more preferably about 15-70 wt %. The third phase of the sequential polymerization may comprise about 5-80 wt % of the latex, preferably about 10-75 wt %, and more preferably about 15-60 wt %.

The multi-stage sequential emulsion polymerization is conducted so that the seed and the core layers contain monomers that form polymers with relatively higher T_{g} values, while the shell layer contain monomers that form polymers with relatively lower T_{g} values. The first phase of the multi-stage sequential emulsion polymerization is the preparation of the relatively hard seed in situ, using monomers that form polymers with relatively higher T_{g} values. The second phase of the multi-stage sequential emulsion polymerization is the formation of the relatively hard core by feeding a monomer mixture that form polymers with relatively higher T_{g} values. The third phase of the multi-stage sequential emulsion polymerization is the formation of the relatively soft shell by feeding a monomer mixture that form polymers with relatively lower T_{g} values.

By controlling the monomers in each phase of the multi-stage sequential emulsion polymerization, the latex of the invention will contain 10-50 wt % of monomers responsible for hardness, 30-60 wt % of monomers responsible for softness, and about 2-20 wt % of monomers rendering hydrophilic and functional groups to the latex. In another aspect, the latex is sequentially polymerized in at least two stages with at least one stage, e.g., the shell, being hydrophilic. The hydrophilic stage is bonded to at least one type of hydrophobic molecule.

The reaction mixture of the multi-stage sequential emulsion polymerization for the latex of the invention may also utilize a coalescing agent, an open time agent, an initiator, a pH adjustor, a chaser solution, a crosslinking agent, a preservative, and any suitable combination thereof. The latex thus prepared is suitable for low VOC or zero VOC applications and a variety of finishes of the paint.

VOC is defined according to U.S. Environmental Protection Agency (EPA) Method 24. “Low-VOC” compositions and components can have a VOC content of not more than about 250 g/L (about 25% w/v), preferably not more than about 150 g/L (about 15% w/v), more preferably not more than about 100 g/L (about 10% w/v), most preferably not more than about 50 g/L (about 5% w/v), for example not more than about 30 g/L (about 3% w/v) or not more than about 20 g/L (about 2% w/v).

“Zero-VOC” compositions can also be part of the low-VOC compositions of this invention. Zero-VOC compositions can advantageously have a VOC content of not more than about 10 g/L (about 1% w/v), preferably not more than about 8 g/L (about 0.8% w/v), more preferably not more than about 5 g/L (about 0.5% w/v), for example not more than about 2 g/L (about 0.2% w/v).

To be useful for low VOC or zero VOC paint compositions while maintaining outstanding paint properties, the latex of the invention uses monomers that form polymers with different T_{g} for the seed, the core and the shell. Specifically, monomers for the seed and the core are those that form polymers of relatively higher T_{g} and monomers for the shell are those that form polymers of relatively lower T_{g} in order to avoid poor paint properties such as poor block resistance and dirt pick up.

Coalescing agents assist the formation of a film during the drying process of the paint. Examples of low-VOC coalescing agents can include, but are not limited to, fatty acid alkylene glycol monoesters (e.g., those compounds sold under the tradename Archer RC™ from Archer Daniels Midland), aromatic alkoxylates (e.g., cresol propoxylates such as those compounds sold under the tradename PLURACOAT™, including PLURACOAT™ CA120, PLURACOAT™ CA110, and PLURACOAT™ CA100), those compounds sold under the tradename EDENOL™ from Cognis (e.g., EDENOL™ EFC 100), those compounds sold under the tradename OPTIFILM™ from Eastman Chemical (e.g., OPTIFILM™ Enhancer 400), and the like, and combinations thereof. While less preferred, the low-VOC composition can contain traditional (VOC) coalescence solvents, which can include, but are not limited to, 2-ethylhexyl ether of ethylene glycol (e.g., commercially available from Eastman Chemical as Eastman™ EEH solvent), alkyl esters of aromatic carboxylic acids (e.g., 2-ethylhexyl benzoate and/or those compounds sold under the tradename Velate™ 368 from Velsicol Chemical Corp.), methyl carbitol, propylene glycol, ethylene glycol, optionally-alkyl-substituted alkanediol organic carboxylic acid monoesters (e.g., 2,2,4-trimethyl-1,3-pentanediol monoisobutyrate and those compounds sold under the tradename Texanol™ from Eastman Chemical), phosphate salts such as potassium tetrapyrophosphate, plasticizers such as dibutyl phthalate, and the like, and combinations thereof.

The amounts of low-VOC coalescing agent(s) used for the paints derived from the latex of the invention may be in the range of about 0.01 to 10 wt %, preferably from about 0.02 to 8 wt %, more preferably from about 0.05 to 7 wt %, most preferably from about 0.1 to 5 wt %.

Open time agents for latex coating compositions are typically compounds having a relatively low molecular weight (e.g., a number average molecular weight from about 1,000 Daltons to about 100,000 Daltons) and containing a relatively high content of hydrophilic functional groups (e.g., hydroxyls, carboxylic acids, and the like, and combinations thereof). In the case of acrylic-based and/or acrylic-/styrenic-based polymer coating compositions, open time agents can generally also be acrylic-based. The relatively high concentration of hydrophilic functional groups can, in some cases, advantageously give open time agents a relatively large hydroxyl number (e.g., at least about 100) and/or acid number. The relatively high concentration of hydrophilic functional groups can also advantageously cause a paint composition, for example, containing the open time agent to have the function of maintaining its viscosity, fluidity, flowability, re-wettability and/or brushability for extended periods of time, e.g., to allow a consumer/user sufficient time to coat a surface relatively smoothly and relatively evenly.

Examples of low-VOC open time agents can include, but are not limited to, those compounds sold under the tradenames FLOTROL™, FLOETROL™, and/or FLUOTROL™, e.g., from the Flood Company of Hudson, OH, those compounds sold by Morgan Associates of Hometown, Pa. under the tradename WONDERWE™, and the like, and combinations thereof.

The amount of low-VOC open time agents in the paints derived from the latex of the invention may be in the range of about 0.01 to 10 wt %, preferably from about 0.02 to 8 wt %, more preferably from about 0.05 to 7 wt %, most preferably from about 0.1 to 5 wt %.

Examples of pH adjustors useful in the compositions according to the invention can include, but are not limited to, ammonium hydroxide, sodium hydroxide, sodium carbonate, sodium bicarbonate, potassium hydroxide, potassium carbonate, potassium bicarbonate, ammonium salts, ammonia, amines, aminoalcohols (e.g., 2-amino-2-methyl-1-propanol and/or those compounds sold under the tradename AMP™ 95 by Angus Chemical Co.), and the like, and combinations thereof. Preferred pH adjustors include ammonia, amines and aminoalcohols. In certain cases, compounds that qualify as pH adjustors can be added for purposes other than adjusting pH (e.g., temporary deactivation of otherwise reactive functional groups, emulsion stabilization, or the like), and yet are still characterized herein as pH adjustors.

The compositions according to the invention can advantageously exhibit a pH from about 6 to 10, preferably from about 7 to 9.5, more preferably from about 8 to 9.5, although the pH needs only to be sufficient to maintain the stability of the particular composition, in combination with any additives present.

Low-VOC crosslinking agents (and crosslinking agents, in general) can typically include at least one crosslinkable functional group (and usually at least two crosslinkable functional groups) capable of reacting with a corresponding reactive (crosslinkable functional) group on another molecule. Non-limiting examples of crosslinkable functional groups include epoxies, silanes, silane ethers, amines, hydroxyls, carboxylic acids, carboxylates, amides, urethanes, thiourethanes, ureas, thioureas, isocyanates, isothiocyanates, acid halides, aldehydes, anhydrides, and the like, and combinations thereof. In a preferred embodiment, the low-VOC crosslinking agent contains both a silane ether functional group and an epoxy functional group (i.e., an epoxysilane). In another preferred embodiment, the crosslinking agent does not include, and in some preferred embodiments specifically excludes, any compound and/or functional group that participates in, facilitates, or catalyzes oxidative crosslinking (e.g., atmospheric oxygen can cause oxidative crosslinking of pendant ethylenic unsaturations and other residual hydrocarbon double bonds). In another embodiment, the crosslinking agent does not include, and in some embodiments specifically excludes, organometallic catalysts (e.g., titanium carboxy-esters that can ester exchange with crosslinkable groups such as silanes to activate a crosslinking reaction).

The low-VOC crosslinking agents in the paints derived from the latex of the invention may be in the range of about 0.01 to 20 wt %, preferably from about 0.02 to 15 wt %, more preferably from about 0.05 to 10 wt %, most preferably from about 0.1 to 8 wt

Crosslinking agents, coalescing agents, and open-time agents that are characterized as being low-VOC typically exhibit a higher molecular weight than other (standard) agents of a similar type, typically contain an increased number of functional groups than other (standard) agents of a similar type, or both. Preferred coalescing agents include those that, regardless of molecular weight, contain at least one or two functional groups capable of reacting with the crosslinking agents present in the compositions according to the invention. Similarly, preferred open time agents include those that, regardless of molecular weight, contain at least two functional groups capable of reacting with the crosslinking agents present in the compositions according to the invention.

The types of finishes of the paints using the latex of the invention can be high gloss, semi-gloss, satin or “silk”, eggshell, or flat. The degree of shininess, or gloss, is determined by the amount of pigment present in the paint. Without any pigment, most binders will yield a high gloss finish. Gloss is measured in reflectivity of the painted surface at 20°, 60°, and 85° from the vertical position.

TABLE 2
The Typical Reflectivity of Paints with Different
Gloss At Different Angles

| Type of Paint | 20° Gloss | 60° Gloss | 80° Gloss |
|---|---|---|---|
| High Gloss | 20–90 | 70–95 | — |
| Semi-Gloss | 5–45 | 25–75 | — |
| Satin | — | 5–25 | 10–40 |
| Eggshell | — | 2–15 | 5–25 |
| Flat | — | 0–10 | 0–15 |

Pigment volume concentration (“PVC”) can also be used to describe the paint in terms of the volume of the pigment and the volume of the binder. Therefore, the percentage of PVC (“PVC %”) can be calculated using the equation:

PVC %=[(Volume of Pigments)/(Volume of Pigments+Volume of Binder)]×100

TABLE 3
The Typical PVC % Values of Different Types of Finishes

| Type of Paint | PVC % |
|---|---|
| High Gloss | 15 |
| Semi-Gloss | 25 |
| Satin | 35 |
| Eggshell | 35–45 |
| Flat | 38–80 |

Examples of initiators and chaser solutions useful in the latex compositions according to the invention can include, but are not limited to, ammonium persulfate, sodium persulfate, potassium persulfate, redox systems such as sodium hydroxymethanesulfinate (reducer) and t-butyl-hydroperoxide (oxidizer), and the like, and combinations thereof, typically in an aqueous solution. Either or both of these components can optionally contain an additional surfactant and/or a pH adjustor, if desired to stabilize the emulsion.

Examples of surfactants useful in the paint compositions according to the invention can include, but are not limited to, nonionic and/or anionic surfactants such as ammonium nonoxynol-4 sulfate, nonylphenol ethoxylate(10), octylphenol ethoxylate(9-10), sodium dodecylbenzene sulfonate, sodium dodecyl sulfonate, sodium tetradecyl sulfonate, sodium hexadecyl sulfonate, those sold under the tradename Triton™ (e.g., QS series, CF series, X series, and the like), those sold under the tradename Igepal™, those sold under the tradename Rhodapon™, those sold under the tradename Rhodapex™, those sold under the tradename Rhodafac™, those sold under the tradename Rhodacal™, and the like, and combinations thereof.

Examples of dispersants useful in the paint compositions according to the invention can include, but are not limited to, 2-amino-2-methyl-1-propanol, hydrophobic copolymers such as Tamol™ 165A, Tamol™ 1124, and combinations thereof.

Examples of preservatives or biocides useful in the paint compositions according to the invention can include, but are not limited to, hydroxy-functional aza-dioxabicyclo compounds such as those commercially available from ISP under the tradename Nuosept™ 95.

Examples of defoamers useful in the paint compositions according to the invention can include, but are not limited to, polysiloxane-polyether copolymers such as those sold by Tego under the tradename Foamex™, those sold under the tradename BYK™, those sold under the tradename Drewplus™, those sold under the tradename Surfynol™, and the like, and combinations thereof.

Examples of anticorrosive agents useful in the paint compositions according to the invention can include, but are not limited to, sodium nitrite and the like.

Examples of rheology modifiers useful in the paint compositions according to the invention can include, but are not limited to, those commercially available from Rohm & Haas under the tradename Acrysol™, such as RM-2020 NPR and RM-825.

While typically multiple pigments/colorants are present in end-use latexes that are to be used in paint or architectural coating applications, sometimes only a white pigment, such as a zinc oxide and/or a titanium oxide, is added in the early stages of the formation of the paint composition (e.g., in the base composition). In such a case, any other desired pigments/colorants of various colors (including more white pigment) can optionally be added at the later stages of, or after, formation of the paint composition. Examples of pigments/colorants useful according to the invention can include, but are not limited to, carbon black, iron oxide black, iron oxide yellow, iron oxide red, iron oxide brown, organic red pigments, including quinacridone red and metallized and non-metallized azo reds (e.g., lithols, lithol rubine, toluidine red, naphthol red), phthalocyanine blue, phthalocyanine green, mono- or di-arylide yellow, benzimidazolone yellow, heterocyclic yellow, DAN orange, quinacridone magenta, quinacridone violet, and the like, and any combination thereof. These exemplary color pigments can be added as powders, but can more conveniently be added as aqueous dispersions to paint compositions according to the invention. Suitable pigments can be either organic or inorganic.

Additionally or alternately, extender pigments/colorants can be added, e.g., to the grind composition portion of the paint composition. Examples of extender pigments/colorants useful in the paint compositions according to the invention can include, but are not limited to, silica, silicates carbonates such as calcium carbonates, and the like, and combinations thereof.

The paint compositions containing the sequentially polymerized latex polymer according to the invention can exhibit a wide range of viscosities, depending upon the application. In one embodiment, the viscosity of the sequentially polymerized latex can be from about 65 to about 130 Krebunits (KU), preferably from about 70 to about 110 KU, more preferably from about 75 to about 105 KU. While coalescence, degradation, and other factors can cause the viscosity to increase over time, it is preferable that the viscosity not increase beyond about 130 KU, preferably not beyond about 120 KU, more preferably not beyond about 115 KU, and in some cases not beyond about 110 KU.

Advantageously, the paint compositions containing the sequentially polymerized polymer particles according to the invention can exhibit good viscosity stability after composition preparation, while sitting “on the shelf”. Maintaining viscosity stability is desirable to maintain shelf-life and can lead to good shelf stability. Shelf stability can be quantified in many ways. For instance, when measuring viscosity stability, a significant increase in the viscosity from just after composition preparation to as long as 30 days thereafter at ambient temperature (e.g., between about 20° C. and about 30° C.) can indicate a poor shelf stability. In another example measuring incubation stability, a significant increase in the viscosity from just after composition preparation to as long as 30 days thereafter at elevated temperature (e.g., about 120° F.) can indicate a poor shelf stability.

In one preferred embodiment, the viscosity increase between the paint composition prepared soon after polymerization and the paint composition after 30 days at elevated temperature is not more than about 20 KU, preferably not more than about 15 KU, more preferably not more than about 10 KU, and in some cases not more than about 5 KU. In another preferred embodiment, the viscosity increase between the paint composition prepared soon after polymerization and the paint composition after 30 days at elevated temperature is not more than about 25 KU, preferably not more than about 20 KU, more preferably not more than about 15 KU, most preferably not more than about 10 KU.

The latexes and/or paint compositions containing the sequentially polymerized polymer particles according to the invention can advantageously exhibit a pH from about 6 to about 10, although the pH needs only to be sufficient to maintain the stability of the particular latex and/or paint composition in combination with the surfactant(s) and other stabilizing components.

In one embodiment, a paint composition containing sequentially polymerized latex particles according to the invention can be formulated according to the following method. First, a pigment dispersion composition, or grind, is formed by: combining an organic solvent, water, a dispersant, a pH adjustor, a surfactant, a defoamer, a colorant/pigment, and a biocide/preservative; stirring and optionally grinding for a period of time to sufficiently mix the ingredients; and, while continuing to stir and/or grind, adding more water. To this pigment dispersion composition can be added a latex containing sequentially polymerized polymer particle according to the invention, followed by a pH adjustor, if desired, and a performance additive composition comprising, but not limited to, an organic solvent, a surfactant, and a defoamer. Optionally but preferably, an anticorrosive solution can then be added. Then, a rheology modifier can be added, optionally including more water, if desired, and also a pH adjustor, thus forming a paint composition. Furthermore, if desired, more colorant(s) and/or pigment(s) can be added to the paint composition either to compliment the (white) pigment(s)/colorant(s) already in the pigment dispersion composition or to add another desired color to the paint composition. A coalescence solvent may optionally be added later.

### EXAMPLES

The following Examples are merely illustrative of certain embodiments of the invention. The following Examples are not meant to limit the scope and breadth of the present invention, as recited in the appended claims.

### Example 1

### Sequentially Designed Latex Suitable for Gloss Paint

Sequential emulsion polymerization was performed in a 5-liter round bottom reactor equipped with an agitator, a thermocouple, a monomer pre-emulsion feed, an initiator feed, a condenser, and a nitrogen purge system. The temperature of the reactor was maintained by utilizing a water bath. The reactor was charged with 720.0 g of deionized (DI) water, 4.0 g of sodium bicarbonate for pH control, 5.0 g of Rhodafac 610A-25 as surfactant, and 5.0 g of Rhodacal DS-4 as surfactant. The reactor was immersed in the water bath at 65° C. and the content was stirred for 20 minutes under nitrogen purge.

For a “seed” formation, 8.0 g of styrene as monomers responsible for hardness were charged to the reactor followed by a solution of 1.5 g of sodium persulfate as free radical initiator in 15.0 g of DI water, and then nitrogen purge was stopped.

15 minutes later, a feed of monomer pre-emulsion for a “core” was started and continued over a period of 135 minutes. The monomer pre-emulsion for a “core” was prepared by adding 160.0 g of DI water, 16.0 g of Rhodapon UB as anionic surfactant, 28.0 g of HITENOL BC-1025 as polymerizable surfactant, 120.0 g of butyl methacrylate, 272.0 g of styrene, 16.0 g of hydroxyethyl methacrylate and 40.0 g of methacrylic acid, and 6.0 g of Rohamere 6852-0.

45 minutes after monomer pre-emulsion feed was started, 112.0 grams of butyl acrylate were added to monomer pre-emulsion as monomers responsible for softness. This was the start of the shell and can be considered as the transitional shell.

135 minutes after monomer pre-emulsion feed was started, components of the “shell” were added to monomer pre-emulsion: 16.0 g of Rohamere 6852-0, 216.0 g of butyl acrylate as monomers responsible for softness, 8.0 g of hydroxyethyl methacrylate as monomers responsible for hydrophilic and functional groups, 16.0 g of diacetone acrylamide as hydrophilic monomers that are reactive to other components for crosslinking purposes, and 8.0 g of methacrylic acid for hydrophilic and functional group purposes. At this point, a feed of a solution of 1.0 g of sodium persulfate as free radical initiator in 64.0 g of water started over a period of 90 minutes.

After all the feeds were completed, the reaction was heated to 82° C. for an additional 45 minutes. Afterwards, the reaction was cooled to 52° C. and a solution of 0.6 g of sodium formaldehyde sulfoxylate as a reductant in the chaser in 16.0 g of DI Water was added followed by a solution of 0.8 g of 70% tert-butyl hydroperoxide as an oxidizer in the chaser in 16.0 g of DI Water. After cooling to ambient temperature, the pH of the latex was adjusted to 8.5 by ammonia solution, 30 g of Silquest® A-2287 silane were added and the latex was filtered.

The paint made with the this latex has very good coalescence at 4.5° C., gloss of above 85% and very good gloss retention, and other paint properties such as wet adhesion, block resistance, stain removal, and scrub resistance.

### Example 2

### Sequentially Designed Latex Suitable of Paint with Semi-Gloss Finish

Sequential emulsion polymerization was performed in a 5-liter round bottom reactor equipped with an agitator, a thermocouple, a monomer pre-emulsion feed, an initiator feed, a condenser, and a nitrogen purge system. The temperature of the reactor was maintained by utilizing a water bath. The reactor was charged with 370.0 g of deionized (DI) water, 1.0 g of sodium bicarbonate, 1.6 g of Rhodacal A-246/L as sulfonate-based surfactant. The reactor was immersed in the water bath at 65° C. and the content was stirred for 20 minutes under nitrogen purge.

Because the latex according to Example 2 is suitable for a semi-gloss paint, the monomer pre-emulsion for the “seed” and the “core” would be the same. Therefore, the monomer pre-emulsion was prepared by adding 280.0 g of DI water, 32.0 g of Rhodafac 610A-25 as phosphate-based surfactant, 10.0 g of Rhodacal A-246/L as sulfonate-based surfactant, 416.0 g of methyl methacrylate as monomers responsible for hardness, 288.0 grams of butyl acrylate as monomers responsible for softness, 6.0 g of methacrylic acid as monomers for hydrophilic and functional group purposes, and 12.0 g of Rohamere 6844-0 for wet adhesion.

For a seed formation, 42.0 g of the monomer pre-emulsion were charged to the reactor followed by a solution of 1.5 g of sodium persulfate as free radical initiator in 15.0 g of DI water, and then nitrogen purge was stopped.

15 minutes later, a feed of monomer pre-emulsion for a “core” was started and continued over a period of 210 minutes.

105 minutes after monomer pre-emulsion feed was started, components of the “shell” were added to monomer pre-emulsion: 32.0 g of Rohamere 6844-0 for wet adhesion, 88.0 g of butyl acrylate as monomers responsible for softness, and 2.0 g of methacrylic acid as monomers responsible for hydrophilic and functional group purposes. At this point a feed of a solution of 1.0 g of sodium persulfate as free radical initiator in 64.0 g of water started over a period of 110 minutes.

After all feed were completed, the reaction was heated to 82° C. for an additional 45 minutes. Afterwards, the reaction was cooled to 52° C. and a solution of 0.6 g of sodium formaldehyde sulfoxylate as a reductant in the chaser in 16.0 g of DI water was added followed by a solution of 0.8 g of 70% tert-butyl hydroperoxide as oxidizer in the chaser in 16.0 g of DI Water. After cooling to ambient temperature, the pH of the latex was adjusted to 8.5 by ammonia solution, and the latex was filtered.

The paint made with the this latex has very good coalescence at 4° C., and very good paint properties such as wet adhesion, block resistance, stain removal, and scrub resistance.

### Example 3

### Sequentially Designed Latex Containing 13% Hydrophilic Monomers

Sequential emulsion polymerization was performed in 5-liter round bottom reactor equipped with an agitator, a thermocouple, a monomer pre-emulsion feed, an initiator feed, a condenser, and a nitrogen purge system. The temperature of the reactor was maintained by utilizing a water bath. The reactor was charged with 720.0 g of deionized (DI) water, 4.0 g of sodium bicarbonate for pH control, 5.0 g of Rhodafac 610A-25, and 5.0 g of Rhodacal DS-4 as surfactants. The reactor was immersed in the water bath at 65° C. and the content was stirred for 20 minutes under nitrogen purge.

For a seed formation, 8.0 g of styrene were charged to the reactor followed by a solution of 1.5 g of sodium persulfate in 15.0 g of DI water, and then nitrogen purge was stopped.

15 minutes later, a feed of monomer pre-emulsion for a “core” was started and continued over a period of 135 minutes. The monomer pre-emulsion for a “core” was prepared by adding 160.0 g of DI water, 16.0 g of Rhodapon UB, 28.0 g of HITENOL BC-1025, 80.0 g of butyl methacrylate, 272.0 g of styrene, 16.0 g of hydroxyethyl methacrylate, 32.0 g of methacrylic acid, and 6.0 grams of Rohamere 6852-0.

45 minutes after monomer pre-emulsion feed was started, 120.0 g of butyl acrylate were added to monomer pre-emulsion. This was the start of the shell, and also be considered as the transitional shell.

135 minutes after monomer pre-emulsion feed was started, components of “shell” were added to monomer pre-emulsion: 16.0 g of Rohamere 6852-0, 256.0 g of butyl acrylate, 8.0 g of hydroxyethyl methacrylate, 40.0 g of diacetone acrylamide, and 8.0 g of methacrylic acid. At this point, a feed of a solution of 1.0 g of sodium persulfate in 64.0 g of water was started over a period of 90 minutes.

After all the feeds were completed, the reaction was heated to 82° C. for an additional 45 minutes. After 45 minutes at 82° C., the reaction was cooled to 52° C. and a solution of 0.6 g of sodium formaldehyde sulfoxylate as a reductant in the chaser in 16.0 g of DI water was added followed by a solution of 0.8 g of 70% tert-butyl hydroperoxide in 16.0 g of DI water. After cooling to ambient temperature, the pH of the latex was adjusted to 8.5 by ammonia solution, and the latex was filtered.

The paint made with the above latex has very good coalescence at 4.5° C., gloss above 85% and very good gloss retention, wet adhesion, block resistance, stain removal, and scrub resistance.

### Example 4

### Sequentially Designed Laxtex Containing 2% Hydrophilic Monomers

Sequential emulsion polymerization was performed in 5-liter round bottom reactor equipped with a agitator, a thermocouple, a monomer pre-emulsion feed, an initiator feed, a condenser, and a nitrogen purge system. The temperature of the reactor was maintained by utilizing a water bath. The reactor was charged with 720.0 g of deionized (DI) water, 4.0 g of sodium bicarbonate, 5.0 g of Rhodafac 610A-25, and 5.0 grams of Rhodacal DS-4. The reactor was immersed in the water bath at 65° C. and the content was stirred for 20 minutes under nitrogen purge.

For a seed formation, 8.0 g of styrene were charged to the reactor followed by a solution of 1.5 g of sodium persulfate in 15.0 g of DI water, and then nitrogen purge was stopped.

15 minutes later feed of monomer pre-emulsion for a “core” was started and continued over a period of 135 minutes. Monomer pre-emulsion for a “core” was prepared by adding 160.0 g of DI water, 16.0 g of Rhodapon UB, 28.0 g of HITENOL BC-1025, 96.0 g of butyl methacrylate, 272.0 g of styrene, 8.0 g of methacrylic acid, and 6.0 g of Rohamere 6852-0.

45 minutes after monomer pre-emulsion feed was started, 120.0 g of butyl acrylate were added to monomer pre-emulsion. 135 minutes after monomer pre-emulsion feed was started, components of “shell” were added to monomer pre-emulsion: 16.0 g of Rohamere 6852-0, 264.0 g of butyl acrylate, and 8.0 g of methacrylic acid. At this point a feed of a solution of 1.0 g of sodium persulfate in 64.0 g of water started over a period of 90 minutes.

After all the feeds were completed, the reaction was heated to 82° C. for an additional 45 minutes. Afterwards, the reaction was cooled to 52° C. and a solution of 0.6 g of sodium formaldehyde sulfoxylate as a reductant in the chaser in 16.0 g of DI water was added followed by a solution of 0.8 g of 70% tert-butyl hydroperoxide in 16:0 g of DI water. After cooling to ambient temperature, the pH of the latex was adjusted to 8.5 by ammonia solution, and the latex was filtered.

### Example 5 Latex Prepared from Latexes of Eamples 3 AND 4

Latex can be used as an additive or a mixture with other latex so that latexes having good open time properties can be formulated. In this Example 5, 20% of the latex having 13 wt % hydrophilic monomers from Example 3 is mixed with 80% of the latex having only 2% hydrophilic monomers from Example 4.

Comparison of Open Time Among Latexes

Open time of latexes from Examples 3, 4 and 5 are compared. In terms of time to lose wet appearance and touch dry time, Example 3 shows the best open time characteristics, Example 4 shows normal open time characteristics, and Example 5, being a mixture of Examples 3 and 4, possesses about 70% of the open time characteristics of Example 3, even though only 20% of the latex in Example 3 is used in Example 5. See Table below.

TABLE 4
Open Time Comparison of Latexes from Examples 3, 4 and 5

| | Time To Lose Wet | Touch Dry Time |
|---|---|---|
| Latex | Appearance (Minutes) | (Minutes) |
| Ex. 3: Sequential Latex with | 20 | 25 |
| 13% hydrophilic monomer | | |
| Ex. 4: Sequential Latex with | 14 | 20 |
| 2% hydrophilic monomer | | |
| Ex. 5: 20% of Example 3 and | 18 | 23.5 |
| 20% of Example 4 | | |

### Example 6

### High Gloss Paint Based on Latex from Example 1

Example 6 is a high gloss white paint with VOC at 48 g/L prepared from the latex of Example 1.

TABLE 5
Paint Formulation of Example 6

| Ingredients in Paint | Quantity (Pounds) |
|---|---|
| Dipropylene Glycol | 8.52 |
| Water | 47.42 |
| Biocide (KATHON LX 1.5% | 0.94 |
| BIO) | |
| Dispersant (TAMOL 1124) | 7.66 |
| pH Neutralizer (AMP 95) | 0.56 |
| Pigment (TiPure 706) | 212.57 |
| Defoamer (Byk 024) | 0.66 |
| Paste from above ingredients | |
| (using COWLES mixing | |
| blades) was added to latex | |
| below | |
| Latex (Example 3) | 628.66 |
| Cross-Linker (ADH) | 9.46 |
| pH Neutralizer (AMP95) | 1.39 |
| Water | 52.19 |
| Zero VOC Coalescence Aid | 20.87 |
| (Pluracoat CA 120) | |
| Surfactant (IGEPAL CO- | 3.48 |
| 887) | |
| Defoamer (Byk 024) | 1.74 |
| Thickener (ACRYSOL RM- | 9.39 |
| 2020) | |
| Total Weight | 1025.00 |

### Example 7

### Comaparative High Gloss Paint from Commercial Latex

Example 7 is a commercially available high gloss white paint (309 High Gloss from Benjamin Moore) having VOC at 250 g/L, which in turn is prepared from a commercially available latex (HG 1630 from Rohm & Haas).

TABLE 6
Paint Property Comparison of Examples 6 and 7

| | Example 6 | Comparative Example |
|---|---|---|
| | (Paint using Latex | 7 (Paint using Latex |
| Paint Properties | from Example 1) | HG 1630) |
| Block Resistance | Pass | Fail (50% off) |
| (1 week dry) | | |
| Scrub Resistance | 1000 Cycles | 400 Cycles |
| (2 week dry) | | |
| Water Resistance | Pass | Fail |
| (1 day dry) | | |
| Low Temperature | Pass | Pass |
| Coalescence at 40° F. | | |
| Wet Adhesion | Pass | Pass |
| (1 week dry) | | |

The paint in Example 6 exhibited better flow and leveling, better open time during application by brushing when compared with paint in Example 7. The paint in Example 6 also exhibited better sandability when compared with paint in Example 7 due to the crosslinking nature of the monomers therein.

### Examples 8 & 9

### Repair Time of High Gloss Paints

High gloss paint examples were prepared for their repair time comparison. Repair time is another indication of open time and is described below. Example 8 was based on a commercial latex polymer available from Benjamin Moore. Example 9 was based on the latex prepared according to Example 3, which contains 13% hydrophilic monomers The formulation of Example 9, shown in Table 7, also is similar to the formulation of Example 10.

TABLE 7
Paint Formulation of Example 9

| Ingredients in Paint | Quantity (Pounds) |
|---|---|
| Dipropylene Glycol | 8.52 |
| Water | 47.42 |
| Biocide (KATHON LX 1.5% | 0.94 |
| BIO) | |
| Dispersant (TAMOL 1124) | 7.66 |
| pH Neutralizer (AMP 95) | 0.56 |
| Pigment (TiPure 706) | 212.57 |
| Defoamer (Byk 024) | 0.66 |
| Paste from above ingredients | |
| (using COWLES mixing | |
| blades) was added to latex | |
| below | |
| Latex (Example 3) | 628.66 |
| Cross-Linker (ADH) | 9.46 |
| pH Neutralizer (AMP95) | 1.39 |
| Water | 52.19 |
| Zero VOC Coalescence Aid | 20.87 |
| (Pluracoat CA 120) | |
| Surfactant (IGEPAL CO- | 3.48 |
| 887) | |
| Defoamer (Byk 024) | 1.74 |
| Thickener (ACRYSOL RM- | 9.39 |
| 2020) | |
| Total Weight | 1025.00 |

Repair time at 77° F. was performed for paint Examples 8 and 9. As shown in Table 8, the repair time for paint Example 9 was improved at both 15% and 60% relative humidity.

TABLE 8
Repair “Open” Time Comparison at 77° F.

| | Repair “Open” Time | Repair “Open” Time |
|---|---|---|
| | at 15% Rel. Humidity | at 60% Rel. Humidity |
| Paints | (Minutes) | (Minutes) |
| Comparative Example 8 | 0.25 | 5.0 |
| (Based on Latex from | | |
| Benjamin Moore) | | |
| Example 9 (Based on | 1.0 | 6.0 |
| Latex from Example 3) | | |

### Examples 10 & 11

### Repair Time of High Gloss Paints with or without “Open Time Agent”

High gloss paint examples were prepared for their repair time comparison. Paint Example 10 was based on the latex prepared according to Example 3, which contains 13% hydrophilic monomers, but without the open time agent Wonderwet IV. Paint Example 11 was based on the latex according to Example 3 and with the open time agent Wonderwet IV. The details of the paint formulation can be found in Table 9 and the repair time comparison in Table 10.

TABLE 9
Paint Formulation of Examples 10 and 11

| | Quantity in Paint | Quantity in Paint |
|---|---|---|
| Ingredients in Paint | Example 10 (Pounds) | Example 11 (Pounds) |
| Dipropylene Glycol | 8.52 | 8.25 |
| Water | 47.42 | 47.42 |
| Biocide (KATHON LX | 0.94 | 0.94 |
| 1.5% BIO) | | |
| Dispersant (TAMOL | 7.66 | 7.66 |
| 1124) | | |
| pH Neutralizer (AMP 95) | 0.56 | 0.56 |
| Pigment (TiPure 706) | 212.57 | 212.57 |
| Defoamer (Byk 024) | 0.66 | 0.66 |
| Paste from above | | |
| ingredients (using | | |
| COWLES mixing blades) | | |
| was added to latex below | | |
| Latex (Example 3) | 640.25 | 628.66 |
| Cross-Linker (ADH) | 9.46 | 9.46 |
| pH Neutralizer (AMP95) | 1.39 | 1.39 |
| Water | 60.08 | 52.19 |
| Zero VOC Coalescence | 20.87 | 20.87 |
| Aid (Pluracoat CA 120) | | |
| Surfactant (IGEPAL CO- | 3.48 | 3.48 |
| 887) | | |
| Open Time Agent | 0.00 | 19.48 |
| (Wonderwet IV) | | |
| Defoamer (Byk 024) | 1.74 | 1.74 |
| Thickener (ACRYSOL | 9.39 | 9.39 |
| RM-2020) | | |
| Total Weight | 1025.00 | 1025.00 |

TABLE 10
Repair “Open” Time Comparison of
Examples 10 and 11 at 77° F.

| | | Repair “Open” |
|---|---|---|
| | Repair “Open” Time | Time at 50% Rel. |
| | at 20% Rel. Humidity | Humidity |
| Paints | (Minutes) | (Minutes) |
| Example 10 (Without | 1.0 | 3.5 |
| Wonderwet IV) | | |
| Example 11 (With | 2.0 | 4.5 |
| Wonderwet IV | | |

### Examples 12 & 13

### Repair Time of High Gloss Paints from High Hydrophilic and Low Hydrophylic Latexes

High gloss paint examples were prepared from high hydrophilic and low hydrophilic latexes for their repair time comparison. Paint Example 12 was based on the high hydrophilic latex prepared according to Example 3. Paint Example 13 was based on the low hydrophilic latex according to Example 4. The details of the paint formulation can be found in Table 11.

TABLE 11
Paint Formulation of Examples 12 and 13

| | Quantity in | Quantity in Paint |
|---|---|---|
| | Paint Example | Example 13 (Pounds) |
| | 12 (Pounds) with High | with Low Hydrophilic |
| Ingredients in Paint | Hydrophilic Latex | Latex |
| Dipropylene Glycol | 8.52 | 8.25 |
| Water | 47.42 | 47.42 |
| Biocide (KATHON LX | 0.94 | 0.94 |
| 1.5% BIO) | | |
| Dispersant (TAMOL | 7.66 | 7.66 |
| 1124) | | |
| pH Neutralizer (AMP | 0.56 | 0.56 |
| 95) | | |
| Pigment (TiPure 706) | 212.57 | 212.57 |
| Defoamer (Byk 024) | 0.66 | 0.66 |
| Paste from above | | |
| ingredients (using | | |
| COWLES mixing | | |
| blades) was added to | | |
| latex below | | |
| Latex | 609.19 | 609.19 |
| | Example 3 | Example 4 |
| Cross-Linker (ADH) | 9.46 | 9.46 |
| pH Neutralizer | 1.39 | 1.39 |
| (AMP95) | | |
| Water | 52.19 | 52.19 |
| Zero VOC Coalescence | 20.87 | 20.87 |
| Aid (Pluracoat CA 120) | | |
| Surfactant (IGEPAL | 3.48 | 3.48 |
| CO-887) | | |
| Open Time Agent | 19.48 | 19.48 |
| (Wonderwet IV) | | |
| Defoamer (Byk 024) | 1.74 | 1.74 |
| Thickener (ACRYSOL | 9.39 | 9.39 |
| RM-5000) | | |
| Thickener (ACRYSOL | 19.48 | 19.48 |
| RM-5) | | |
| Total Weight | 1025.00 | 1025.00 |

### Comparison of Open Time of Paints From Examples 12 & 13

Low VOC paints (Examples 12 and 13) were compared for their open time properties. At equal KU (85) and ICI (1.15), Examples 12 and 13 were brushed on factory-primed doors. Example 12 exhibited significantly better open time as indicated by easier cutting back in and no wet edge being observed. Example 13 exhibited wet edge and were not able to cut back in. Example 12 also exhibited acceptable water resistance, wet adhesion, scrub resistance and block resistance. The repair “open” time comparison is summarized in Table 12.

TABLE 12
Repair “Open” Time Comparison of
Examples 12 and 13 at 77° F.

| | Repair “Open” Time at 50% |
|---|---|
| Paints | Rel. Humidity (Minutes) |
| Example 12 (Based on | 2.5 |
| Latex from Example 3) | |
| Example 13 (Based on | 3.5 |
| Latex from Example 4) | |

Latexes prepared according to Examples 1-3 were tested for minimum film formation temperatures (MFFT). MFFT were determined by the use of an instrument MFFT Bar-90 according to ASTM D2354-98 (Standard Test Method for Minimum Film Formation Temperature of Emulsion Vehicles). Temperature range was between 0° C. (the cold end) and 18° C. (the warm end). Emulsions were applied using 75 micron cube applicator from the warm end on the right to the cold end on the left to form tracks. Emulsions were allowed to dry for 3 hours. When films have formed, the MFFT were determined as points on tracks where the film has coalesced over 90% of the track width. For all the inventive latexes tested, the MFFT were about 0.5 to 2° C.

Block resistance, or the propensity of a coating to adhere to itself instead of to its substrate, was measured according to a modified version of ASTM D4946. On a sealed white Leneta™ WK card, three 9″-wide draw down coatings of samples of about 3 mils thickness were prepared side by side and allowed to cure for about 1 week at room temperature (e.g., from about 20-25° C.). After curing, each of the three draw down coating samples was cut into four 1″ squares. Two of these squares were oriented face to face (i.e., coated sides touching) and are placed under a 100-gram weight in a 120° F. oven for about 24 hours. The other two of these squares were oriented face to face and placed under a 100-gram weight at room temperature for about 24 hours. Both sets of face to face squares were then allowed to equilibrate to ambient temperature for about ½ hour. Each set of squares was then pulled apart using a slow and steady force, forming a T pattern. Block resistance was rated on a scale of 1 to 5, with 1 representing no tackiness (which includes both the sound and the feel of separation upon peeling), 2 representing a slight tackiness, 3 representing a moderate tackiness, 4 representing a high level of tackiness, and 5 representing transfer of at least a portion of one of the coatings away from its substrate and onto the other coating. The relative percentage of transfer of the coating was also noted.

Scrub resistance was measured according to a modified version of ASTM D2486 Method B. A scrub panel was created with three 9″-wide draw down coatings of samples of about 7 mils thickness prepared side by side (at least one of the samples should be a control sample) and allowed to cure horizontally for about 2 weeks at room temperature (e.g., from about 20-25° C.). Black scrub panels were preferably used for coating compositions that are white, pastel, and medium colors. In addition, an extra scrub panel was used as a conditioning panel. On a Gardner™ Abrasion Tester, the night before testing, a medium bristle brush was soaked in DI water overnight. Just before the testing, the excess water was shaken from the brush, and the brush was placed in the brush holder. Before testing the scrub panels, the conditioning panel was secured in the Gardner™ Abrasion Tester. With a wooden tongue depressor, about 10 grams of abrasive scrub medium was applied to the brush, and about 5 cc of DI water was syringed evenly across the panel in the area to be scrubbed. The conditioning panel was scrubbed for about 400 cycles. Thereafter, the conditioning panel was removed and discarded, the brush was washed with water, and each scrub panel was secured in the Gardner™ Abrasion Tester. Like with the conditioning panel, the abrasive scrub medium was applied to the brush, and the water was applied to the panel. The scrub panel was then scrubbed for a maximum of about 2000 cycles (typically about 1 hour). About every 100 cycles, excess scrub medium was moved from outside the scrub area to inside the scrub area. About every 400 cycles, another 10 grams of scrub medium is added to the brush, and another 5 cc of DI water was syringed onto the scrub area. The number of cycles it took to remove one continuous line of each coating was noted. This process was repeated for each scrub panel.

Water resistance tests were performed using controlled condensation conditions according to ASTM D4585-99. Using a 3-mil bar, test and control paints on a sealed DD card are drawn down. The paints are allowed to air dry for 24 hours. To test for water resistance, the DD card is laid horizontally, and 3 drops of water are added to each sample and allowed to soak for one minute. The samples are blotted dry and scratched with a finger nail. Blisters are visually checked. Samples are evaluated as equal to, better than or worse than the control.

Low-temperature coalescence was measured according to a modified version of ASTM D3793. For each sample, a number of 6″×12″ Upson panels were cooled to about 40° F. for about 1 hour. On one half (6″×6″ portion) of each panel, a draw down coating of each composition was prepared having a thickness starting at about 3 mils and going to about 24 mils. These panels were then kept about 40° F. in a refrigerator for about 24 hours, and were allowed to recover for about ½ hour at room temperature, after which point the panels were left overnight. The presence or absence of visible cracks on each panel was noted and rated from 3 to 24, based on the thinnest panel on which cracks were first evident, with each number represent its mil-thickness, and with 24 representing that either only the 24-mil thick panel or none of the panels showed cracks.

Wet adhesion was measured using test conditions specified under ASTM D3359. Various 3-mil thick draw down coatings of paint compositions were applied to panels and let dry overnight, for about 7 days, and for about 14 days. After drying, wet and dry adhesion of the paint coatings were evaluated using Scotch™ 600 tape and a 6×6 cross-hatch adhesion standard test, as detailed in ASTM D3359 Method B. For wet adhesion, the coated panels were placed in 100% humidity for about 1 hour and were blotted dry prior to the cross-hatch test. The adhesion ratings range from 0B through 5B, based on the relative percent area of flaking/peeling within the 6×6 cross-hatch area. 5B=no flaking; 4B=less than 5% flaking; 3B=5-15% flaking; 2B=15-35% flaking; 1B=35-65% flaking; 0B=more than 65% flaking.

Open time test method for latex can be carried out according to the following procedure. 3 Mil drawdowns were made on sealed Leneta Form 1B. The drying behavior was monitored as a function of time. The time at which the films lost wet look and the time at which the films were dry to touch were recorded. The test was performed at 25° C. and at 50% humidity.

Open time test method for paint can be carried out by measuring the repair time, which is an expression of how paint examples will remain open after application. Repair time is measured by securing black Leneta Chart to an aluminum drawdown plate in the CTR. Test paints are drawn down lengthwise on the chart using the 5 mil opening of the drawdown block. Five “X's” are marked in the film using the tip of tongue depressor, and time is noted immediately with a stopwatch. At time intervals of 1 minute, or 30-seconds, a 2-inch nylon brush with 0.5-inch to 0.75-inch of the test paint is brushed across the drawdown from one side of the chart to the other side. A minimum of 15 strokes of fresh paint are applied over the “X” marks until the brush drag increases dramatically. This step is repeated until all five “X” marks are brushed over. The test substrates are allowed to dry for 16 to 24 hours in the CTR. The chart is examined for defects. The repair time for a test paint will be the last time interval at which the “X” marks do not show through. The temperature and the relative humidity are also recorded.

While various embodiments of the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. A latex polymer comprising sequentially designed polymer having at least a first stage, a second stage, and a third stage, wherein
monomers for the first stage are those that form polymers having glass transition temperature in the range of 30 to 110° C.,
monomers for the second stage are those that form polymers having glass transition temperature in the range of 30 to 70° C., and
monomers of the third stage are those that form polymers having glass transition temperature in the range of −10 to 10° C.,
whereby the latex is suitable for paints with a volatile organic component (VOC) content of less than 50 g/L.

2. The latex polymer of claim 1, wherein
the first stage comprises a seed of the sequentially designed polymer,
the second stage comprises a core of the sequentially designed polymer, and
the third stage comprises a shell of the sequentially designed polymer.

3. The latex polymer of claim 1, wherein monomers for the first stage are those that form polymers having-glass transition temperature in the range of 70 to 110° C.

4. The latex polymer of claim 1, wherein monomers for the first stage are those that form polymers having glass transition temperature that changes gradually from the range of 70 to 110° C. to the range of 30 to 70° C.

5. The latex polymer of claim 1, wherein monomers for the first stage are selected from the group consisting of methyl(meth)acrylate, ethyl(meth)acrylate, n-propyl(meth)acrylate, isopropyl(meth)acrylate, n-butyl(meth)acrylate, isobutyl(meth)acrylate, pentyl(meth)acrylate, 2-ethylhexyl(meth)acrylate, decyl(meth)acrylate, dodecyl(meth)acrylate, stearyl(meth)acrylate, α-chloroethyl(meth)acrylate, cyclohexyl(meth)acrylate, phenyl(meth)acrylate, methoxyethyl(meth)acrylate, ethoxyethyl(meth)acrylate, methoxypropyl(meth)acrylate, ethoxypropyl(meth)acrylate, styrene, methylstyrene, chlorostyrene, and methoxystyrene.

6. The latex polymer of claim 1, wherein monomers for the first stage are methyl methacrylate, butyl methacrylate, styrene or a combination thereof.

7. The latex polymer of claim 1, wherein the monomers for the second stage constitute 10 to 50 wt % of the latex.

8. The latex polymer of claim 1, wherein monomers for the second stage are selected from the group consisting of methyl(meth)acrylate, ethyl(meth)acrylate, n-propyl(meth)acrylate, isopropyl(meth)acrylate, n-butyl(meth)acrylate, isobutyl(meth)acrylate, pentyl(meth)acrylate, 2-ethylhexyl(meth)acrylate, decyl(meth)acrylate, dodecyl(meth)acrylate, stearyl(meth)acrylate, α-chloroethyl(meth)acrylate, cyclohexyl(meth)acrylate, phenyl(meth)acrylate, methoxyethyl(meth)acrylate, ethoxyethyl(meth)acrylate, methoxypropyl(meth)acrylate, ethoxypropyl(meth)acrylate, styrene, methylstyrene, chlorostyrene, and methoxystyrene.

9. The latex polymer of claim 1, wherein monomers for the second stage are methyl methacrylate, butyl methacrylate, styrene or a combination thereof.

10. The latex polymer of claim 1, wherein monomers for the second stage are acrylic acid, methacrylic acid, hydroxyethyl acrylate, hydroxyethyl methacrylate, acetoacetoxyethyl methacrylate, diacetone acrylamide, and any combination thereof.

11. The latex polymer of claim 1, wherein monomers for the third stage constitute 10 to 60 wt % of the latex.

12. The latex polymer of claim 1, wherein monomers for the third stage are selected from the group consisting of butyl acrylate, 2-ethylhexyl acrylate, butyl methacrylate, and styrene.

13. The latex polymer of claim 1, wherein monomers for the third stage optionally contain acrylic acid, methacrylic acid, itaconic acid, hydroxyethyl acrylate, hydroxyethyl methacrylate, acetoacetoxyethyl methacrylate, diacetone acrylamide, and any combination thereof.

14. The latex polymer of claim 1, wherin the glass transition temperature follows a decreasing gradient from the first stage to the third stage.

15. A sequential emulsion polymerization method for a latex for low VOC comprising the steps of:
preparing a monomer pre-emulsion mixture for first stage,
preparing a monomer pre-emulsion mixture for second stage,
treating the monomer pre-emulsion mixture for first stage with a solution of sodium persulfate to form a first stage,
treating the first stage with the monomer pre-emulsion mixture for second stage to form a second stage,
treating the second stage with polymer components for third stage to form a third stage,
whereby the latex is suitable for paints with a volatile organic component (VOC) content of less than 50 g/L.

16. The method of claim 15, wherein
the first stage comprises a seed of the sequentially designed polymer,
the second stage comprises a core of the sequentially designed polymer, and
the third stage comprises a shell of the sequentially designed polymer.

17. The method of claim 15, wherein
the monomer pre-emulsion mixture for first stage comprises monomers that form polymers having glass transition temperature in the range of 30 to 110° C.,
the monomer pre-emulsion mixture for second stage comprises monomers that form polymers having glass transition temperature in the range of 30 to 70° C., and
the polymer components for third stage comprise monomers that form polymers having glass transition temperature in the range of −10 to 10° C.

18. The method of 17, wherein
the monomer pre-emulsion mixture for first stage comprises monomers that form polymers having glass transition temperature in the range of 70 to 110° C.

19. The method of claim 15, wherein the glass transition temperature of the latex polymer decreases from the first stage to the third stage.

20. A sequentially designed polymer having a first stage, a second stage, a third stage, and at least one intermediate stage, wherein
monomers of the first stage, monomers of the second stage, and monomers of the third stage form polymers with a gradient of glass transition temperatures, and
the at least one intermediate stage have glass transition temperatures that follow the gradient of glass transition temperature.

21. The latex polymer of claim 20, wherein
the first stage comprises a seed of the sequentially designed polymer,
the second stage comprises a core of the sequentially designed polymer, and
the third stage comprises a shell of the sequentially designed polymer.

22. The latex polymer of claim 20, wherein the intermediate stage is located between the first stage and the second stage.

23. The latex polymer of claim 20, wherein the intermediate stage is located between the second stage and the third stage.

24. The latex polymer of claim 20, wherein the intermediate stage is located between the first stage and the second stage, and between the second stage and the third stage.

25. The latex polymer of claim 20, wherein
monomers for the first stage are those that form polymers having glass transition temperature in the range of 30 to 110° C.,
monomers for the second stage are those that form polymers having glass transition temperature in the range of 30 to 70° C.,
monomers of the third stage are those that form polymers having glass transition temperature in the range of −10 to 10° C.,
whereby the latex is suitable for paints with a volatile organic component (VOC) content of less than 50 g/L.

26. The latex polymer of claim 20, wherein the monomers for the first stage are those that form polymers having glass transition temperature in the range of 70 to 110° C.

27. A latex polymer comprising a sequentially designed polymer having a first stage, a second stage and a third stage, wherein monomers of the first stage, monomers of the second stage, and monomers of the third stage form polymers with an aggregate glass transition temperature for the latex polymer T_{g}(−) in the range of 0 to 70° C.

28. The latex polymer of claim 27, wherein the aggregate T_{g}(−) is in the range of 10 to 60° C.

29. The latex polymer of claim 27, wherein the aggregate T_{g}(−) is in the range of 20 to 50° C.

30. A latex polymer, comprising sequentially designed polymer having a first stage, a second stage, and a third stage, wherein a combination of monomers of the first stage, monomers of the second stage, and monomers of the third stage results in a minimum film forming temperature for the latex polymer in the range of −10 to 10° C.

31. The latex polymer of claim 30, wherein the minimum film forming temperature for the latex polymer is in the range of 0.5 to 2° C.

32. A latex polymer for paints with improved open time comprising sequentially designed polymer having a first stage, a second stage, and a third stage wherein monomers for the first stage, monomers of the second stage, and monomers of the third stage contain 5 to 20% of hydrophilic monomers.

33. The latex of claim 32, wherein monomers of the first stage, monomers of the second stage, and monomers of the third stage contain 10 to 15% of hydrophilic monomers.

34. The latex of claim 32, wherein monomers of the first stage, monomers of the second stage, and monomers of the third stage contain 4 to 7% methacrylic acid, 2 to 5% hydroxyethyl methacrylate, and 3 to 6% diacetone acrylamide.

35. A sequentially emulsified polymer having at least two stages, wherein at least one stage is hydrophilic and at least one stage is bonded to at least one hydrophobe, said hydrophobe is represented by the general formula:
H₂C═C(X)—C(O)O-E-R
where
X is hydrogen or methyl,
E is ethoxylate, and
R is alkyl, alkylphenyl, monostyrylphenyl, distyrylphenyl or tristyrylphenyl.

36. The polymer of claim 35, wherein the hydrophobe is bonded to the hydrophilic stage.

37. The polymer of claim 35 further comprising a third stage.

38. A latex polymer comprising at least a core and a shell and at least a means selecting from the group of
(i) a means for improving the block resistance of a film formed by said latex polymer;
(ii) a means for improving the open time of a film formed by said latex polymer: and
(iii) a means for forming a surfactant by grafting a hydrophobic molecule to said latex polymer.
